(19) United States
(12) Patent Application Publication
(10) Pub. No.: US 2008/0192979 A1
(43) Pub. Date: Aug. 14, 2008

(54) SHOT PATTERN AND TARGET DISPLAY

(76) Inventor: Christopher Bee, Buxton (GB)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/771,078

(22) Filed: Jun. 29, 2007

(30) Foreign Application Priority Data
Jul. 4, 2006 (GB) 0613268.2

(51) Int. Cl. G06F 19/00

(52) U.S. Cl. 382/103; 700/91

(57) ABSTRACT

A display system for representing a shooter's performance by capturing and displaying an image of a shot pattern in mid-air in relation to a moving target, comprising an image capturing device arranged to capture such an image at an instant when such a shot pattern and such a target are both an equal distance from such a shooter.

### RELATED APPLICATION DATA

This application claims the benefit of Great Britain Application No. 0613268.2 filed Jul. 4, 2006, the disclosure of which is incorporated herein by reference in its entirety.

The present invention relates to a display system and method for representing a shooter's performance by capturing a shot pattern in mid air in relation to a moving target, for example a shot pattern from a shotgun in relation to a clay pigeon.

In the shooting of a moving target, using a shotgun, a shot pattern is generated consisting of typically 240 pellets travelling at around 300 m.s⁻¹. A problem with training in this type of shooting is that it is not possible to observe where the shot pattern has gone with respect to the moving target. This makes it difficult to conceptualise how the target is being missed so that appropriate adjustment to shooting technique can be made. At present experienced shooters can advise a training shooter with very subjective descriptions how to adjust their technique in order to hit the target. Experienced shooters often refer to the shape of the shot pattern and how the movement of the shotgun affects the shape of the shot pattern, even though it is not possible to observe the shot pattern. The effects of gun handling technique, shotgun type and shotgun set up on the shooter's chances of hitting the target are known to have been modelled based on observations on large static ground targets, known as patterning plates. Tracer ammunition has been found to be ineffective in this role due to the tendency for the tracer and shot to become separated in flight.

A tuition system for clay pigeon shooting, which uses high-speed cameras for improving gun handling technique, is known.

According to a first aspect of the present invention there is provided a display system for representing a shooter's performance by capturing and displaying an image of a shot pattern in mid-air in relation to a moving target, comprising an image capturing device arranged to capture the image at an instant when the shot pattern and the target are both an equal distance from the shooter.

Thus, the present invention is able to provide a shooter with immediate feedback of shooting performance, by showing the shooter the position of the shot pattern in relation to the position of the target, without having to process large amounts of moving picture data. The system does this by capturing and displaying a high resolution image of the instant when the target and the shot pattern are at an equal distance from the vicinity of the shooter.

The display system may additionally comprise a computing device for controlling the instant of image capture by the image capturing device.

The display system may additionally comprising a pan and tilt mount on which the image capturing device is mounted, wherein the computing device controls the orientation of the pan and tilt mount, so as to direct the image capturing device. In this way the image capturing device, for example a digital camera, can be directly oriented so as to capture the image of the shot pattern with respect to the target. In particular, the display system may additionally comprise an inclinometer and directional indicator (hereafter referred to as the inclinometer) fitted to a gun of the shooter under evaluation and connected to the computing device, wherein the computing device, in response to the inclinometer, controls the pan and tilt mount, so that the direction of the image capturing device follows the direction in which such a gun is pointed.

The display system according may additionally include a range finding device, connected to the computing device for detecting the distance between the target and the shooter and the range finder is preferably supported on the pan and tilt mount.

The display system may additionally comprise a detector, for example an accelerometer, fitted to a gun of a shooter under evaluation for detecting a firing event of such a gun and connected to the computing device, wherein the computing device, in response to the detection of a firing event, initiates image capture by the image capture device. In addition, it is preferred that the computing device, in response to detection of a firing event, halts the pan and tilt mount, so that the image capturing device is directed in the correct direction to capture the image.

Where the display system additionally includes a range finder, the computing device may calculate, in response to the detection of a firing event, the instant when a shot pattern fired from a gun of a shooter under evaluation is an equal distance from the shooter as the distance detected by the range finder, and the computing device controls the image capture device to capture the image at the calculated instance. Usually, the computing device will include a screen, in which case the computing device may display the image captured by the image capture device on the screen.

According to a second aspect of the present invention, there is provided a method of representing a shooter's performance comprising the step of capturing and displaying an image of a shot pattern in mid-air in relation to a moving target when such a shot pattern and such a target are both an equal distance from such a shooter.

The method may comprise the steps of:
controlling the orientation of an image capture device and a target range finding device, so that the devices follow the direction in which a gun of such a shooter is pointing;
detecting, using the range finding device the distance to such a target;
detecting a gun firing event;
calculating the instant, after such a gun firing event when a shot pattern fired from such a gun is at the same distance from such a shooter as the distance detected by the range finder; and
controlling the image capture device to capture the image at the calculated instance.

The method may comprise the additional step of fixing the orientation of the image capture device in response to the detection of a firing event.

The system is preferably located immediately adjacent to or directly in front of the shooter.

The display system according to the present invention, will generally be directly underneath the user or slightly offset. However, the field of view of image capture devices are generally of the order of 5 degrees or so and will accommodate small distances between the system and the shooter. Larger distances between the display system and the shooter could be adjusted for account in the set-up of the display system.

The invention will now be described by way of example only and with reference to the accompanying schematic drawings, wherein:

FIG. 1 shows an display system according to the present invention in the process of capturing a shot pattern with respect to a clay pigeon;

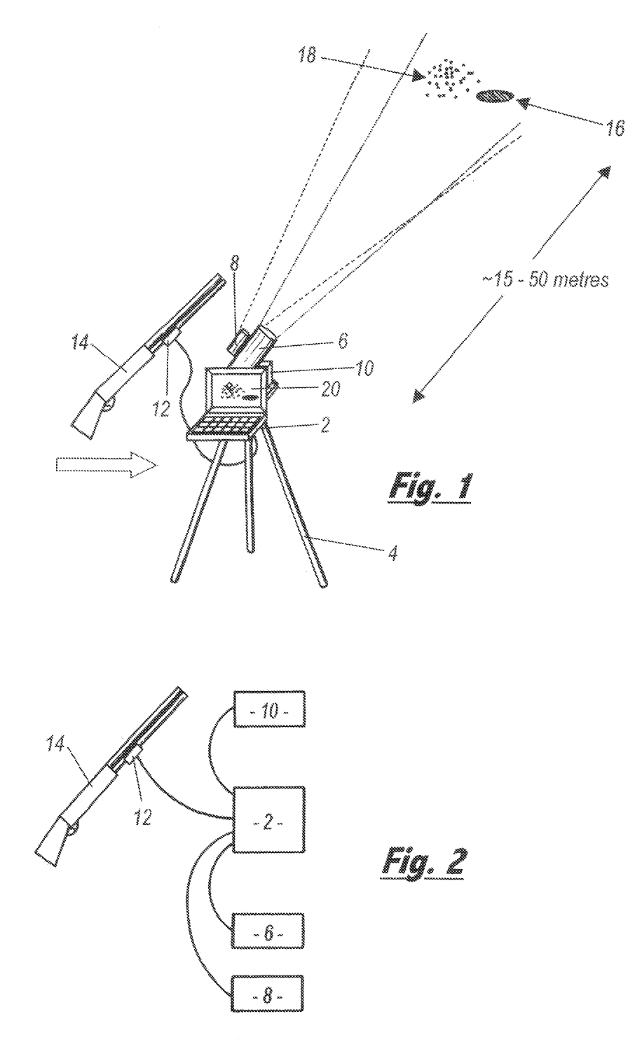

FIG. 2 shows a block diagram of the components making up the display system of FIG. 1 and their interrelation; and

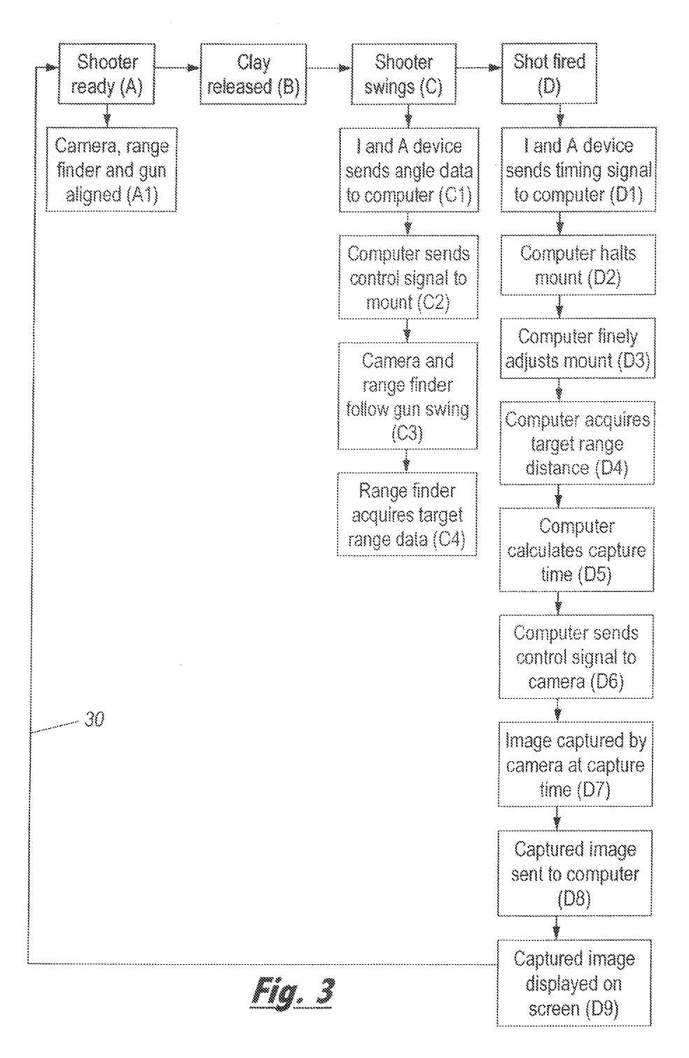

FIG. 3 shows a flow diagram of the operation of the display system of FIGS. 1 and 2.

The display system of FIGS. 1 and 2 comprises a computing device (2), for example a lap top micro-computer, mounted on a support tripod (4). A high resolution image capture device (6), such as a digital spotting camera, and a range finder (8) are mounted adjacent to each other on an automated pan and tilt mount (10), with their optical axes parallel to each other. The pan and tilt mount (10) is itself mounted on the support tripod (4). The pan and tilt mount (10) is preferably capable of a speed of movement of the order of 300° per second. The range finder (8) may be for example an infra-red range finder of the type currently used for tank level indication. An accurate and fast responding inclinometer and accelerometer (I and A) device (12) is mounted on a shotgun (14) co-axially with the bore or bores of the gun. The I and A device (12) is lightweight and relatively small in volume and so can be mounted on the shotgun (14) without adversely affecting the gun's handling characteristics.

The shotgun (14) under evaluation, as shown in FIG. 1 is a double barrelled shotgun. However, many of the shotguns used in clay shooting are semi-automatic, i.e. single barrelled with a mechanism for ejecting the empty case of the first shot and loading the next shot into the same barrel.

The computing device (2) receives inputs from the I and A device (12), range finder (8), camera (6) and pan and tilt mount (10) and generates outputs to control the operation of the mount (10) and the camera (6). The display system of FIGS. 1 and 2 can be made self calibrating by referencing the inclinometer of the I and A device (12) to the pan and tilt mount (10). This can be done, for example, by using a bar attachment on the pan/tilt base to which zero inclination and direction for both inclinometer and pan/tilt mount are referenced. This allows the system to be operated on rough ground without accurate levelling.

The display system of FIGS. 1 and 2 is positioned adjacent to a shooter of the gun (14) and operates as follows, with reference to the flow diagram of FIG. 3. When the shooter is ready to shoot [Box A; FIG. 3], the inclinometer of the I an A device (12) will, in real time, send angle data to the computing device (2). This angle data includes pan angle data representative of the angle of the shotgun bores in the horizontal plane as well as tilt angle data representative of the inclination of the shotgun bores to the horizontal. The computing device (2) receives this data and is programmed in response to generate a control signal to the pan and tilt mount (10) to ensure that the optical axes of the camera (6) and range finder (8) are aligned with the direction in which the bores of the shotgun (14) are pointing [Box A1; FIG. 3]. Parallax effects will be minimised by the siting of the device as close as possible to the user. Where this is not possible, small corrections could be made within the computing device (2) to take this into account.

Then on release of a clay pigeon (16) [Box B; FIG. 3], the shooter swings the gun (14) to follow the movement of the clay pigeon [Box C; FIG. 3]. The inclinometer of the I an A device (12) sends angle data to the computing device (2) [Box C1; FIG. 3]. The computing device (2) receives this data and is programmed in response to generate a control signal to the pan and tilt mount (10) [Box C2; FIG. 3] and the camera (6) and range finder (8) follow the swing of the gun (14) [Box C3; FIG. 3]. During this movement the range finder (8) acquires range data about the target [Box C4; FIG. 3], the clay pigeon (16), ie. the distance between the target and the range finder (8), and thus effectively between the range finder (8) and the gun (14).

The event of the shooter firing the gun (14) [Box D; FIG. 3] is very quickly detected by the accelerometer of the I and A device (12) mounted on the gun (14). A timing signal representing the occurrence of this event is sent by the accelerometer to the computing device (2) [Box D1; FIG. 3]. On receipt of this timing signal, the computing device (2) sends a control signal to halt the movement of the pan and tilt mount (10) [Box D2; FIG. 3]. If necessary, the halted position if the pan and tilt mount (10) is finely adjusted by the computing device to take into account any systematic error, for example, generated by any delay between the firing of the shot and the halting of the pan and tilt mount (10) [Box D3; FIG. 3]. At this instant the computing device (2) acquires a reading from the range finder (8) representing the distance between the range finder (8) and the target (16) [Box D4; FIG. 3]. Then the computing device (2) calculates from the muzzle velocity of the shot (a property of the gun (14) and the type of ammunition used) the time (referred to herein as the capture time) at which both the shot pattern (18) and the target (16) are an equal distance from the camera (6) [Box D5; FIG. 3]. Typically, this distance is in a range between around 15 and 50 meters. The computing device (2) then sends a control signal to the camera (6) to capture an image at the capture time [Box D6; FIG. 3] and the camera captures the image [Box D7; FIG. 3]. As the camera (6) is directed towards the direction of the shot, the captured image shows the position and arrangement of the shot pattern (18) in relation to the position of the target (14). Many available cameras are focus tolerant, but if necessary, the focus of the camera (6) could be adjusted by the computing device, based on the distance acquired by the computing device (2) from range finder (8).

A signal representing the captured image is then sent by the camera (6) to the computing device (2) [Box D8; FIG. 3] and the image is immediately displayed on a screen (20) of the computing device (2), as shown in FIG. 1 [Box D9; FIG. 3].

Shotguns generally have two shots and so generally two clay pigeons are released in quick succession. Once the image has been captured by the camera (6), the computing device (2) sends a control signal to the pan and tilt mount (10) [See arrow (30) in FIG. 3] to re-align the camera (6) and range finder (8) with the bores of the gun (14) so that the next shot can be recorded in exactly the same way as is described above. The two images so captured, can be displayed side by side on the screen (20) so as to provide feedback to the shooter about the relationship between the shot pattern (18) and the target (16). This enables the shooter to adjust gun handling technique so as to improve the accuracy of subsequent shots.

When the target (16) is missed, inspection of the image on the screen (20) of the computing device (2) enables the shooter to see where the shot pattern (18) went in relation to the target (16) and also enables the shooter to study the shape of the shot pattern (18). This enables the shooter to adjust their shooting technique so as to improve their accuracy. This is of benefit to all level of shooters, from beginners to advanced.

1. A display system for representing shooter's performance by capturing and displaying an image of a shot pattern in mid-air in relation to a moving target, comprising an image capturing device arranged to capture such an image at an instant when such a shot pattern and such a target are both an equal distance from such a shooter.

2. A display system according to claim 1 additionally comprising a computing device for controlling the instant of image capture by the image capturing device.

3. A display system according to claim 2, additionally comprising a pan and tilt mount on which the image capturing device is mounted, wherein the computing device controls the orientation of the pan and tilt mount, so as to direct the image capturing device.

4. A display system according to claim 3, additionally comprising an inclinometer fitted to a gun of such a shooter and connected to the computing device, wherein the computing device, in response to the inclinometer, controls the pan and tilt mount, so that the direction of the image capturing device follows the direction in which such a gun is pointed.

5. A display system according to claim 3 additionally including a range finder, connected to the computing device for detecting the distance between such a target and such a shooter.

6. A display system according to claim 5 wherein the range finder is supported on the pan and tilt mount.

7. A display system according to claim 2, additionally comprising a detector fitted to a gun of such a shooter for detecting a firing event of such a gun and connected to the computing device, wherein the computing device, in response to the detection of a firing event, initiates image capture by the image capturing device.

8. A display system according to claim 3, wherein the computing device, in response to detection of a firing event, halts the pan and tilt mount.

9. A display system according to claim 7 additionally including a range finder, connected to the computing device for detecting the distance between such a target and such a shooter, wherein the computing device calculates, in response to the detection of a firing event, the instant when a shot pattern fired from such a gun is an equal distance from such a shooter as the distance detected by the range finder, and the computing device controls the image capturing device to capture the image at the calculated instance.

10. A display system according to claim 2 wherein the computing device includes a screen and the computing device displays the image captured by the image capturing device on the screen.

11. A method of representing a shooter's performance comprising the step of capturing and displaying an image of a shot pattern in mid-air in relation to a moving target when such a shot pattern and such a target are both an equal distance from such a shooter.

12. A method according to claim 11 comprising the steps of:
controlling the orientation of an image capturing device and a target range finding device, so that the devices follow the direction in which a gun under evaluation is pointing;
detecting, using the range finding device the distance to such a target;
detecting a gun firing event;
calculating the instant, after such a gun firing event when a shot pattern fired from a gun of such a shooter is at the same distance as the distance detected by the range finder; and
controlling the image capturing device to capture the image at the calculated instance.

13. A method according to claim 12 comprising the additional step of fixing the orientation of the image capturing device in response to the detection of a firing event.
